(19) United States
(12) Patent Application Publication
(10) Pub. No.: US 2024/0417272 A1
(43) Pub. Date: Dec. 19, 2024

(54) SOLID ELECTROLYTE MATERIALS, PROCESS FOR PRODUCTION AND USES THEREOF

(71) Applicant: EVONIK OPERATIONS GMBH, Essen (DE)

(72) Inventors: Harald ALFF, Kahl (DE); Jessica ANTONI, Nidderau (DE); Silvia BLANK-SHIM, Aschaffenburg (DE); Alessandro DANI, Düsseldorf (DE); Regina FUCHS-WINKLER, Ingelheim (DE); Elisabeth GORMAN, Haltern am See (DE); Michael HUG, Mömbris (DE); Christian HYING, Rhede (DE); Sabrina JURETZKA, Frankfurt am Main (DE); Huong KLINK-TRAN, Mannheim (DE); Theresa KÜSTER, Hanau (DE); Sabine KUZNIK, Bremen (DE); Frank LÖFFLER, Heppenheim (DE); Heiko MENNERICH, Heppenheim (DE); Anne MERTLICH, Gründau (DE); Durdu SCHÄFER, Rodgau (DE); Franz SCHMIDT, Groß-Gerau (DE); Tanja SEITZ, Langenselbold (DE); Tobias STADTMÜLLER, Seligenstadt (DE); Patrik STENNER, Hanau (DE); Silke SUHR, Mömbris (DE); Ryo TAKATA, Tokyo (JP); Yikalo-Eyob TECLE, Shanghai (CN); Armin WIEGAND, Großkrotzenburg (DE)

(73) Assignee: EVONIK OPERATIONS GMBH, Essen (DE)

(21) Appl. No.: 18/706,637

(22) PCT Filed: Oct. 28, 2022
(86) PCT No.: PCT/EP2022/080157

§ 371 Date: May 1, 2024

(30) Foreign Application Priority Data
Nov. 2, 2021 (EP) 21205986.9

(51) Int. Cl. C01G 23/00; H01M 4/04; H01M 4/58

(52) U.S. Cl. CPC C01G 23/002; H01M 4/0471; H01M 4/5825; C01P 2004/51

(57) ABSTRACT

A process for producing a lithium titanium phosphate based solid electrolyte material is disclosed, the process comprising the steps of: (i) providing a solution comprising a Li source material, a Ti source material, a P source material and optionally a Si source material and/or a source material of a metal M, wherein M is selected from the group of Al, Ga, Ge, In, Sc, V, Cr, Mn, Co, Fe, Y, the lanthanides or a combination thereof; (ii) generating an aerosol from the solution; (iii) subjecting the generated aerosol to flame pyrolysis to form a particulate precursor material therefrom; and (iv) subjecting the particulate precursor material to field-assisted sintering to form the lithium titanium phosphate based solid electrolyte material. Furthermore, disclosed are a solid electrolyte material obtainable through said production process and articles comprising the same.

### TECHNICAL FIELD

The present invention relates to solid electrolyte materials and methods for their production. More specifically, the present invention is directed to a process for producing lithium titanium phosphate based solid electrolyte materials, which involves producing a particulate precursor material by flame pyrolysis and subjecting the same to a subsequent field-assisted sintering step. The invention further relates to articles comprising such formed solid electrolyte materials and their uses, for example as electrolysis membrane in processes for separation of lithium from end-of-use lithium batteries.

### TECHNICAL BACKGROUND

Lithium plays a crucial role in today's rechargeable energy storage devices for many applications such as for electrical vehicles, portable devices and intermittent energy storage facilities for storing energy from renewable sources like solar and wind energy. In view of the enormously increasing use of lithium-based energy storage devices and the limited lithium resources, recycling of such devices at the end of their use is both commercially and environmentally interesting. Processes for separation of lithium from-end-of-use battery material can for example comprise subjecting the material obtained from shredding end-of-use batteries to a leaching treatment, which dissolves inter alia metals like lithium contained therein. In a subsequent step, such lithium can be recovered from the mixtures via an electrolysis process. An electrolysis process is based on a current-driven redox reaction and is carried out by supplying an appropriate voltage difference to two electrodes, i.e., anode and cathode, which are in contact with the metal-containing solution and which are typically separated by a membrane of a solid electrolyte material. Solid electrolyte materials exhibit selective conductivity for ions such as for lithium ions and thus facilitate ion exchange between the half cells of anode and cathode. Industrial electrolysis processes impose high requirements on the employed electrolysis membranes such as their electrical properties and reliability and resistance against mechanical failure. Similar demanding characteristics are also required when such materials are employed as electrode materials or electrolytes for all-solid lithium-based energy storage devices. Accordingly, there is a strive for providing solid electrolyte materials, which unite a high conductivity for lithium ions and robustness, having a high reliability against mechanical failure.

A typical material utilized for the fabrication of electrolysis membranes or solid electrolytes is for example lithium titanium phosphate (short: LTP). LTP is known as a material having excellent conductivity for lithium ions, which is due to its so-called NASICON-type crystal structure. NASICON is an acronym for sodium (“Na”) Super Ionic CONductor, which typically refers to a group of solids having the chemical formula Na₁₊ₓZr₂SiₓP₃₋ₓO₁₂ with x being 0<x<3. In a broader sense, it is also used for similar compounds, in which Na, Zr and/or Si are replaced by isovalent elements, such as Na by Li. Due to the mobility of the sodium or lithium ions within the crystal structure, NASICON-type compounds are characterized by ionic conductivities on the order of 10⁻⁵ to 10⁻³ S/cm at room temperature. Thereby, sodium or lithium ions are located at two types of interstitial positions in a covalent network consisting of ZrO₆/TiO₆ octahedra and SiO₄/PO₄ tetrahedra, which share common corners. When moving between these two interstitial sites, the sodium or lithium ions have to pass bottlenecks, whose size accordingly influences the ion conductivity of the NASICON-type material. By altering the chemical composition of the NASICON-type material, the size of the bottlenecks can be changed. Thus, the ion conductivity depends inter alia on the specific chemical composition of the material and can be positively influenced by doping with other elements. For instance, it is known that in LTP materials partial substitution of the Ti⁴⁺ ions with M³⁺ cations such as Al³⁺, V³⁺, or Sc³⁺ can create a positive charge defect, which can be compensated by additional Na⁺/Li⁺ ions thus leading to an increased ion conductivity due to the enlarged number of charge carriers. Alternatively or additionally, also the substitution of PO₄ by SiO₄ groups can potentially increase the ion conductivity of the resulting NASICON-type electrolyte material.

Different methods for producing LTP solid electrolytes are known in literature, which typically involve the preparation of a particulate precursor material that is subsequently subjected to a sintering process.

One frequently applied method for preparing a particulate precursor material is sol-gel synthesis as for instance described in EP 3 189 008 B1. The thus obtained gels however have to be extensively dried and milled prior to the sintering process, which is both costly and time-consuming. Additionally, the method according to EP 3 189 008 B1 requires a pre-sintering step at 600° C. in order to remove organic compounds comprised in the obtained gels, which is needed to ensure sintering ability of the particulate precursor material submitted to the sintering step.

Another conventionally applied method in this respect is quenching of a melt comprising the individual components as for example described by Waetzig et al. in Journal of Alloys and Compounds 818 (2020) 153237 for lithium aluminum titanium phosphates (short: LATP). This method, however, requires on the one hand high amounts of energy for melting the educt materials and on the other hand one or more milling steps in order to obtain a sinterable particulate precursor material from the quenched frit.

Conventional sintering processes typically involve preparing a cast film from a suspension comprising the particulate precursor material and subjecting it to sintering temperatures in a furnace as for example described by Yi et al., Journal of Power Sources 269 (2014) 577-588. Thus, heating rates typically achieved with furnaces are in the order of several degrees per minute, which are known to provide rather large grain sizes within the sintered microstructure. Large grain sizes typically contribute to the formation of microcracks which can increase the probability of mechanical failure of the resulting ceramic material.

Accordingly, it is an object of the present invention to provide a method for producing lithium titanium phosphate based solid electrolytes which overcome or alleviate at least some of the above-mentioned deficiencies and limitations of the prior art. In particular, it is an object to provide a process which does not require steps like drying, milling, or pre-sintering and yields solid electrolytes that exhibit both favorable mechanical and ion-conductive properties in an efficient and economic manner, e.g. for electrolysis and energy-storage applications.

### SUMMARY OF INVENTION

This objective and additional advantages as described herein have unexpectedly been achieved by providing a process as defined in appended independent claim 1.

The present invention accordingly relates to a process for producing a lithium titanium phosphate based solid electrolyte material comprising:
i) providing a solution comprising a Li source material, a Ti source material, a P source material and optionally a Si source material and/or a source material of a metal M, wherein M is selected from the group of Al, Ga, Ge, In, Sc, V, Cr, Mn, Co, Fe, Y, the lanthanides or a combination thereof;
ii) generating an aerosol from the solution;
iii) subjecting the generated aerosol to flame pyrolysis to form a particulate precursor material therefrom; and
iv) subjecting the particulate precursor material to field-assisted sintering to form the lithium titanium phosphate based solid electrolyte material.

The present invention is also drawn to a solid electrolyte material obtainable according to the process as disclosed herein. The solid electrolyte material can in particular have a composition according to the formula Li_{n-(1+x+y+z)}M_{n′-x}Ti_{n″-(2-x)}(PO₄)_{(n″)-(3-y)}(SiO₄)_{(n″″)-y}, wherein M is a metal selected from the group of Al, Ga, Ge, In, Sc, V, Cr, Mn, Co, Fe, Y, the lanthanides or a combination thereof, 0≤x≤1, 0≤y≤1, 0≤z≤0.8, and n, n′, n″, n″′ and n″″ each individually being a number in a range from 0.8 to 1.2.

The present invention furthermore relates to an article comprising the solid electrolyte material according to the present invention such as a solid electrolyte, electrode, separator or membrane. For instance, the invention relates to a membrane comprising the solid electrolyte material according to the present disclosure for use in a process for separation and recycling of lithium from end-of-use lithium containing batteries.

Also within the scope of the invention is an energy storage device, such as in particular a lithium battery, comprising a solid electrolyte, electrode and/or separator comprising the solid electrolyte material according to the present invention.

The process of the present invention is based on flame pyrolysis for the production of a particulate precursor material followed by field-assisted sintering of the obtained particulate precursor material and provides several benefits and advantages. Thus, flame pyrolysis immediately produces sinterable particles with a narrow size distribution and relatively small particle sizes, e.g. on the order of 100 nm or less. This can render further processing steps like drying, milling or pre-sintering obsolete. Flame pyrolysis furthermore enables continuous and large-scale synthesis of particulate precursor material with flexible control of the material stoichiometry by variation of the amounts of the precursor materials in the solution subjected to flame pyrolysis. Subsequent field-assisted sintering of the as-obtained precursor material involves high heating rates and short holding times which is believed to facilitate formation of corresponding solid electrolyte materials with small grain sizes and thus low tendency for the formation of microcracks. Unexpectedly, the solid electrolytes obtained according to the process of the present invention show enhanced mechanical properties such as an exceptionally high elastic modulus E, while concomitantly exhibiting competitive Li ion conductivity. This makes the solid electrolytes disclosed herein attractive for use inter alia in lithium batteries or in membranes for industrial electrolysis processes.

### BRIEF DESCRIPTION OF DRAWINGS

FIG. 1 shows the pressure and temperature profiles and the path of the stamp over time during field-assisted sintering of particulate precursor material according to Example 1.

FIG. 2 shows the volume-based particle size distribution of the particulate precursor material produced according to Example 1, as measured by laser diffraction.

FIG. 3 shows the volume-based particle size distribution of a conventional commercially available particulate precursor material used according to Comparative Example 1, as measured by laser diffraction.

FIG. 4 shows the volume-based particle size distribution of the particulate precursor material produced according to Example 3, as measured by laser diffraction.

### DETAILED DESCRIPTION

As used herein, the term “comprising” is understood to be open-ended and to not exclude the presence of additional undescribed or unrecited elements, materials, ingredients or method steps etc. The terms “including”, “containing” and like terms are understood to be synonymous with “comprising”. As used herein, the term “consisting of” is understood to exclude the presence of any unspecified element, ingredient or method step etc.

As used herein, the singular form of “a”, “an”, and “the” include plural referents unless the context clearly dictates otherwise.

Unless indicated to the contrary, the numerical parameters and ranges set forth in the following specification and appended claims are approximations. Notwithstanding that the numerical ranges and parameters setting forth the broad scope of the invention are approximations, the numerical values set forth in the specific examples are reported as precisely as possible. Any numerical values, however, contain errors necessarily resulting from the standard deviation in their respective measurement.

Also, it should be understood that any numerical range recited herein is intended to include all subranges subsumed therein. For example, a range of “1 to 10” is intended to include any and all sub-ranges between and including the recited minimum value of 1 and the recited maximum value of 10, that is, all subranges beginning with a minimum value equal to or greater than 1 and ending with a maximum value equal to or less than 10, and all subranges in between, e.g., 1 to 6.3, or 5.5 to 10, or 2.7 to 6.1.

All parts, amounts, concentrations etc. referred to herein are by weight, unless specified otherwise.

As mentioned above, the present invention relates to a process for producing a lithium titanium phosphate based solid electrolyte material comprising:
i) providing a solution comprising a Li source material, a Ti source material, a P source material and optionally a Si source material and/or a source material of a metal M, wherein M is selected from the group of Al, Ga, Ge, In, Sc, V, Cr, Mn, Co, Fe, Y, the lanthanides or a combination thereof;
ii) generating an aerosol from the solution;
iii) subjecting the generated aerosol to flame pyrolysis to form a particulate precursor material therefrom; and
iv) subjecting the particulate precursor material to field-assisted sintering to form the lithium titanium phosphate based solid electrolyte material.

Accordingly, the present invention provides a process for producing a lithium titanium phosphate based solid electrolyte material. As used herein, a solid lithium titanium phosphate based solid electrolyte material refers to a material in solid phase, which comprises lithium titanium phosphate or a derivative thereof and which exhibits ion-conductivity. Derivatives of lithium titanium phosphate include substituted variants of lithium titanium phosphate (LiTi₂P₃O₁₂) in which part of the constituent atoms have been substituted by other elements such as a part of the P atoms substituted e.g. by Si and/or a part of the Ti atoms substituted by a metal M, wherein M can for example be selected from the group of Al, Ga, Ge, In, Sc, V, Cr, Mn, Co, Fe, Y, the lanthanides or a combination thereof, wherein such substitutions can be counterbalanced e.g. by the lithium content to yield overall electroneutrality. Alternatively or in addition, there can be a deficiency or excess of one or more constituent elements of lithium titanium phosphate, such as an excess, e.g. due to occupation of interstitial lattice positions, e.g. a lithium excess, or a deficiency due to vacancies in the lattice, e.g. oxygen deficiency. A lithium titanium phosphate based solid electrolyte material may in particular comprise one or more phases of non-substituted or substituted lithium titanium phosphate in the NASICON-type crystal structure exhibiting ion-conductivity, particularly for lithium ions.

The process for producing a lithium titanium phosphate based solid electrolyte material according to the present invention comprises as set forth above providing a solution comprising a Li source material, a Ti source material, a P source material, and optionally a Si source material and/or a source material of a metal M, wherein M is selected from the group of Al, Ga, Ge, In, Sc, V, Cr, Mn, Co, Fe, Y, the lanthanides or a combination thereof. A solution as used herein refers to a solution in the common sense, i.e. a liquid containing materials (such as the above-mentioned source materials) dissolved in a liquid carrier medium. As such the solution may be substantially or completely free of any undissolved solid or gel-like components or precipitates. The solution is preferably stable over time, i.e., no phase separation or precipitation occurs.

The solution can be provided by adding the Li source material, Ti source material, P source material, and optionally Si source material and/or source material of the metal M, if used, to a suitable solvent and dissolving the source materials in the solvent. It is also possible to prepare solutions of one or more than one source materials and combine such solutions and optionally add further source materials or optional ingredients to form the solution comprising a Li source material, a Ti source material, a P source material, and optionally a Si source material and/or a source material of a metal M. Preparation of the solution can involve mixing the individual source materials (which as set forth above can be provided e.g. in neat form or a mixture or solution), solvent and further optional components, if any, at room or elevated temperature in a suitable mixing device such as a beaker or any vessel suited for preparing a solution. Mixing is typically carried out for a duration sufficient to dissolve all solid components such that a clear, homogenous solution is obtained.

A source material of element X means a material that contains the designated element X and thus serves as a source of this element in the process for producing a lithium titanium phosphate based solid electrolyte material. Generally, any Li source material, Ti source material, P source material, and optionally Si source material and/or source material of the metal M can be employed as long as a respective solution can be prepared therewith.

Accordingly, any soluble Li-containing material can in principle be employed as the Li source material according to the present invention. Typically, salts, complexes or organometallic compounds of lithium can be utilized as Li source material. Non-limiting examples of inorganic lithium salts are lithium chloride, lithium hydroxide, lithium carbonate, lithium nitrate, lithium bromide, lithium phosphate, and lithium sulfate. Non-limiting examples of organic lithium salts include lithium carboxylates such as lithium salts of C₁-C₂₀ carboxylic acids, such as lithium acetate, lithium oxalate or lithium neodecanoate, lithium alkoxides such as lithium ethoxide or lithium naphthenate. Organic lithium compounds include alkyl lithium and aryl lithium compounds such as for instance butyl lithium or phenyl lithium. Organic complexes of lithium can be exemplified by β-diketonato compounds of lithium such as 2,4-pentandionato-lithium. It may be preferable to employ a Li source material that comprises besides lithium organic moieties which may be removed in the flame pyrolysis step such that substantially no undesirable residuals from the Li source material remain in the resulting particulate precursor material. Accordingly, the Li source material may for example be selected from an organic salt, an organic complex or an organometallic compound of lithium. Preferably, an organic lithium salt such as any one of the organic salts mentioned above can be used as Li-containing material in the process according to the present invention.

Any soluble Ti-containing material can be employed as the Ti source material according to the present invention. Typically, salts, complexes or compounds of titanium can be utilized as Ti source material. Non-limiting examples include halogenides such as titanium tetrachloride, titanium bromide, titanium fluoride, titanium oxysulfate, titanium alkoxides such as titanium methoxide, titanium ethoxide, titanium propoxide, titanium tetraisopropoxide, and titanium butoxide, and acetylacetonato compounds. It may again be preferable to employ a Ti source material that comprises besides titanium organic moieties which may be removed in the flame pyrolysis step such that substantially no undesirable residuals from the Ti source material remain in the resulting particulate precursor material.

Accordingly, the Ti source material may for example be selected from an organic salt, an organic complex or an organometallic compound of titanium. Preferably, an organic titanium salt or compound such as any one of the organic salts and compounds mentioned above can be used as Ti source material in the process according to the present invention.

Any soluble phosphorus-containing material can be used as P source material in the practice of the present invention. For instance, inorganic or organic phosphorus-containing compounds can be used as P source material. Non-limiting examples of such phosphorous-containing compounds include phosphorous halides and oxoacids of phosphorous such as phosphonic acid, orthophosphoric acid, and methaphosphoric acid, pyrophosphoric acid, and salts and esters thereof. Non-limiting examples of such salts and esters include phosphates or pyrophosphates such as ammonium phosphate, sodium phosphate or trialkyl phosphates such as triethyl phosphate, or hydrogen phosphates and dihydrogen phosphates with various counterions such as ammonium or alkali metals. It may be preferable to employ a P source material that comprises besides phosphorus organic moieties which may be removed in the flame pyrolysis step such that substantially no undesirable residuals from the P source material remain in the resulting particulate precursor material. Accordingly, the P source material may preferably comprise an organic phosphorus-containing compound such as an organic phosphate or pyrophosphate, for example a trialkyl phosphate compound such as triethyl phosphate.

As indicated above, optionally a source material of a metal M is used. The source of a metal M can be any soluble material comprising a metal M, wherein M is selected from the group of Al, Ga, Ge, In, Sc, V, Cr, Mn, Co, Fe, Y, the lanthanides or a combination thereof. Typically, salts, complexes or compounds of the metal M can be utilized as source of metal M. It may again be preferable to employ a source material of metal M that comprises besides metal M organic moieties which may be removed in the flame pyrolysis step such that substantially no undesirable residuals from the metal source material remain in the resulting particulate precursor material. Accordingly, the source material of a metal M may for example be selected from an organic salt, an organic complex or an organometallic compound of Al, Ga, Ge, In, Sc, V, Cr, Mn, Co, Fe, Y, the lanthanides or a combination thereof. The metal M may preferably comprise Al. Exemplary Al source materials include inorganic and organic aluminum compounds such as aluminum chloride, aluminum tri-sec-butoxide, and aluminum ethylacetoacetate.

As indicated above, optionally a Si source material is used. Any soluble Si-containing material can in principle be used as Si source material in the practice of the present invention. For instance, silicates or an ester or other derivative of silicic acid can be utilized as Si source material. Exemplary Si-containing compounds include for example silicates and/or organosilicon compounds such as silanoles, siloxanes, and silyl ethers. It may be preferable to employ a Si source material that comprises besides silicon organic moieties which may be removed in the flame pyrolysis step such that substantially no undesirable residuals from the Si source material remain in the resulting particulate precursor material.

It is to be understood that a single source material or a combination or mixture of two or more source materials, such as those indicated above, can each be used for any of the Li source material, Ti source material, P source material, and the optional Si source material and optional source material of the metal M. It is also possible that an employed source material functions as a source of two or more of the mentioned elements. For example, lithium phosphate would represent a Li source material and a P source material. Usually however individual source materials are employed for the Li source material, Ti source material, P source material, and optionally Si source material and/or source material of the metal M.

Although inorganic source materials are in principle suitable, such as those mentioned hereinabove, it is preferable when some or preferably all employed source materials comprise besides the respective source element (Li, Ti, P, Si, metal M) only organic moieties. The organic moieties may be removed in the flame pyrolysis step, e.g. by combustion, such that substantially no undesirable residuals from the source materials remain in the resulting particulate precursor material, which could e.g. adversely affect its sinterability and/or properties of the final lithium titanium phosphate based solid electrolyte material. For instance, the Li source material, the Ti source material, and the source material of a metal M, if used, may each individually be selected from an organic salt, an organic complex or an organometallic compound of the respective metal or a combination thereof, and/or the P source material comprises an ester or salt of an oxoacid of phosphorus, preferably an organic phosphate, and/or the Si source material, if used comprises a silicate and/or an organosilicon compound.

The source materials provide the elements together with the oxygen added in the flame pyrolysis step for forming the particulate precursor material and finally the lithium titanium phosphate based solid electrolyte material in the subsequent steps of the process according to the invention. By varying relative amounts of the Li source material, the Ti source material, the P source material, and the optional Si source material and/or optional source material of the metal M, if used, in the solution the composition of the particulate precursor material and finally of the lithium titanium phosphate based solid electrolyte material produced therefrom can thus be controlled in a flexible manner. Thus, solid electrolyte materials with a predefined stoichiometry can be obtained by preparing a solution with a respective ratio of Li, Ti, P, and optionally Si and/or M. For instance, the source materials can be used in relative amounts for forming a solid electrolyte material having a composition according to or close to the formula Li_{(1+X+y+z)}MₓTi₍₂₋ₓ₎(PO₄)_{(3-y)}(SiO₄)_{y}, wherein M is a metal selected from the group of Al, Ga, Ge, In, Sc, V, Cr, Mn, Co, Fe, Y, the lanthanides or a combination thereof, 0≤x≤1, 0≤y≤1, 0≤z≤0.8, which may be of the NASICON-type crystal structure and exhibit Li ion conductivity. For example, the provided solution can comprise the Li source material, the Ti source material, the P source material and optionally the Si source material and/or source material of a metal M in amounts corresponding to an equivalent ratio Li:(Ti, M):(P, Si) of (0.5 to 2):(1.5 to 2.5):3, preferably of (1.3 to 2):(1.8 to 2.2):3. The equivalent ratio of M:Ti in the solution can for example be in a range from 0 to 1:2, such as from 0 to 1:3 or from 0 to 1:4. In one variant the equivalent ratio of M:Ti is 0, i.e. no source material for metal M is used. The equivalent ratio of Si:P in the solution can be from 0 to 1:2, such as from 0 to 1:3 or from 0 to 1:4, or from 0 to 1:5 or from 0 to 1:10. In one variant the equivalent ratio of Si:P is 0, i.e. no Si source material is used.

As indicated above, furthermore, a solvent is used to prepare the solution comprising the Li source material, Ti source material, P source material and optionally a Si source material and/or a source material of a metal M, if used. Any solvent or mixture of solvents useful to dissolve the Li source material, Ti source material, P source material, and, when used, the optional Si source material and/or metal M source material can be employed. The type and concentration of the one or more solvents can be chosen such that a homogenous and stable solution is obtained, which is preferably free of any undissolved components or precipitates. Possible solvents include inorganic substances such as water and acids or bases such as hydrochloric acid, sulfuric acid, phosphoric acid or alkali hydroxides as well as various organic solvents and mixtures or combinations thereof. In a preferred practice of the present invention, the solution comprises one or more organic solvents. The organic solvents are generally combustible and thus provide additional heat during the flame pyrolysis step of the present invention. Moreover, due to their combustion they typically do not leave any undesirable residues in the particulate precursor material obtained by flame pyrolysis. Any type of common organic solvents can be used according to the present invention such as, without being limited thereto, alcohols, ketones, aldehydes, esters, ethers, carboxylic acids, hydrocarbons or mixtures or combinations thereof. Non-limiting examples of suitable organic solvents or components of solvent mixtures or combination include for instance C₁-C₁₅ alcohols such as ethanol, n-propanol, isopropanol, n-butanol, tert-butanol, methanol, diols such as ethanediol, pentanediol, and 2-methyl-2,4-pentanediol, C₁-C₁₂ carboxylic acids such as acetic acid, propionic acid, butanoic acid, hexanoic acid, oxalic acid, malonic acid, succinic acid, glutaric acid, adipic acid, octanoic acid, 2-ethylhexanoic acid, valeric acid, capric acid, and lauric acid, 2-methoxyethonal, ethers such as diethyl ether and diisopropyl ether, ketones such as acetone or ethyl methyl ketone, esters as such n-butyl acetate or ethyl acetate, hydrocarbons such as alkanes like n-hexane or n-pentane, aromatics such as benzene or toluene, naphtha, gasoline, mineral spirits, or heterocycles such as cyclohexane, 1,4-dioxane, tetrahydrofuran, or pyridine, or acetonitrile. In one example the solvent comprises a mixture of an alcohol, such as ethanol, and a carboxylic acid, such as ethylhexanoic acid. Preferably, the solution is organic solvent based. For example, the solvent may comprise greater than 50 wt. %, such as 60 wt. % or more, or 70 wt. % or more, or 80 wt. % or more, or 90 wt. % or more, or 95 wt. % or more, or 99 wt. % or more, such as 100 wt. %, of organic solvent(s), based on the total weight of the solvent of the solution comprising the Li source material, Ti source material, P source material and optionally a Si source material and/or a source material of a metal M. In a preferred practice of the invention only organic solvents are utilized as solvents in the solution of the different source materials.

Optionally one or more additional components can be used in the solution comprising the Li source material, Ti source material, P source material and optionally a Si source material and/or a source material of a metal M. Non-limiting examples of such additional components include common auxiliary agents such as rheology modifiers, complexing agents, stabilizing agents or alike. For example, one or more than one complexing agent, preferably an organic complexing agent such as ethylenediaminetetraacetic acid, can be used to promote dissolution of one or more than one of the source materials. Such optional additional components, if used, are employed in effective amounts according to conventional practice. For instance, such optional additional components, if used, may be used in amounts in a range from 0.001 to 10 wt. %, based on total weight of the solution.

The solution according to the present invention can be characterized by the concentration of the dissolved source materials of Li, Ti, P, and, if present, Si and M. The solution according to the present invention can for example have a total concentration of the dissolved source materials in a range from 0.5 wt. % to 40 wt. %, such as from 1 wt. % to 30 wt. % or from 2 wt. % to 20 wt. % or from 3 wt. % to 10 wt. %, based on the total weight of the solution.

According to the process of the present invention, the thus prepared solution allows to synthesize via flame pyrolysis a dimensionally and compositionally uniform particulate precursor material. To this end, an aerosol is generated from the solution, which is subjected to flame pyrolysis to form a particulate precursor material therefrom.

Generally, flame pyrolysis refers to the chemical conversion of chemical substances at high temperatures, whereby the high temperatures are supplied by a flame. Typically, these temperatures are in the order of several hundred degree Celsius. Flame pyrolysis and reactors for carrying out the same are as such known in the art and for example described in WO 2015/173114 A1. The reactor typically comprises a reaction chamber hosting an ignition source, means for generating an aerosol from the solution, and means for cooling the particle-gas mixture effluent from the ignition source as well as means for collecting the formed particulate material. The wall of the reaction chamber is typically formed from appropriate heat-resistant materials such as ceramic or glass materials like quartz and can at least partly be equipped with external cooling means. Ignition sources include for example gas torches, laser beams or electric arcs.

In the process according to the present invention an aerosol is generated from the solution comprising the Li source material, Ti source material, P source material and optionally a Si source material and/or a source material of a metal M, typically by the means for generating an aerosol of a flame pyrolysis reactor as mentioned above. An aerosol as understood herein refers to a gas with fine liquid droplets dispersed therein. The average diameter of the droplets of the aerosol may for example be from 1 μm to 150 μm, such as from 30 μm to 100 μm. Generation of the aerosol from the solution can be accomplished by supplying the solution to a nozzle such as those known in the art of aerosol generation like one-component or two-component nozzles. The solution may be heated to increase its vapor pressure and to reduce its viscosity prior to supplying it to the nozzle. Nozzles are generally formed from materials that can tolerate the temperatures present in respective proximity to the flame. Generating an aerosol from the solution may in particular comprise spraying the solution by means of a nozzle using an atomizing gas. In one preferred practice of the invention, the solution is sprayed together with an atomizing gas by means of the individual outlets of a two-component nozzle to obtain an aerosol. Two-component nozzles may be preferred because of high throughputs of the solution and stable flames. The atomizing gas can for example be selected from air, oxygen, nitrogen, or a mixture thereof.

The thus generated aerosol is then subjected in the process according to the present invention to flame pyrolysis to form a particulate precursor material therefrom. This typically comprises contacting the aerosol with a flame, for example in a flame pyrolysis reactor as mentioned above. In one practice of the present invention, the aerosol is supplied to the stable flame of a gas torch. The flame may be generated by combusting a combustible gas with an oxidant. The combustible gas can for example comprise hydrogen, methane, ethane, propane, butane, natural gas and mixtures thereof. The oxidant can comprise oxygen or an oxygen-containing gas mixture like air. For example, the combustible gas comprises hydrogen and the oxidant comprises air. The amount of oxygen is typically chosen such that the combustible gas and the combustible or oxidizable components in the aerosolized solution introduced into the flame are completely combusted or oxidized, respectively. The resulting flame temperature reached during the flame pyrolysis step of the present invention can be from about 400° C. to about 2000° C., and is preferably between about 800° C. and about 1400° C. The combustible components comprised in the aerosol such as the combustible gas, and solvents or organic moieties of the source materials used in the provided initial solution may thus be combusted and converted into gaseous reaction products such as carbon dioxide and/or water molecules. The Li, Ti, P and if used metal M and/or Si components contained in the aerosolized solution are on the other hand oxidized in the flame pyrolysis step and form a particulate precursor material.

The resulting gas-particle mixture effluent from the flame may then be cooled. The flame spray pyrolysis reactor may thus comprise means for cooling the gas-particle mixture effluent from the flame. Such means can for example comprise one or more cooling pipes, which may be cooled with a cooling liquid such as water or an oil.

The formed particulate precursor material may then be separated from the gas stream. Accordingly, the flame spray pyrolysis reactor typically comprises means for collecting the formed particulate precursor material. Suitable means for collecting the particulate precursor material include for example high-temperature membrane filters, cyclone separators, bag filters, electrostatic precipitators and/or thermophoretic-surface collectors.

The thus formed particulate precursor material generally comprises an oxide derived from the used source materials. Accordingly, it represents a particulate lithium titanium phosphate based material. The precise composition depends on the type and relative amounts of the different source materials used. The formed particulate precursor material can in particular have a composition according to the formula Li_{n-(1+x+y+z)}M_{n′-x}Ti_{n″-(2-x)}(PO₄)_{(n″′)-(3-y)}(SiO₄)_{(n″″)-y}, wherein M is a metal selected from the group of Al, Ga, Ge, In, Sc, V, Cr, Mn, Co, Fe, Y, the lanthanides or a combination thereof, 0≤x≤1, 0≤y≤1, 0≤z≤0.8, and n, n′, n″, n″′ and n″″ each individually being a number in a range from 0.8 to 1.2. For instance, x can be in a range from 0.2 to 0.7, such as from 0.3 to 0.6. In addition or alternatively y can be in a range from 0 to 0.8, such as from 0 to 0.6. In a specific variant y is 0 and/or M is Al. Moreover, the parameters n, n′, n″, n″′ and n″″ can each individually be a number in a range from 0.8 to 1.2, such as from 0.9 to 1.1 or from 0.95 to 1.05, such as about or equal to 1.

The obtained particulate precursor material may comprise multiple phases, which can differ in their crystallinity and/or elemental composition. Such phases may include for example AlPO₄, TiO₂, Li₄P₂O₇, LiTi₂PO₄ and LiOH. An ion-conductive lithium titanium phosphate phase e.g. of the NASICON-type crystal structure may be present in the particulate precursor material or may not be present therein in significant amounts. Typically, such ion-conductive phase forms for the most part in the subsequent field-assisted sintering step.

The particulate precursor material according to the present invention can be characterized by its particle size distribution. The particle size can have an influence on the properties of the solid electrolyte material obtainable from particulate precursor material. By tendency smaller particles provide smaller grain sizes, which can reduce the risk of microcrack formation. The particulate precursor material obtained from the flame pyrolysis according to the invention is typically characterized by a small particle size and a narrow particle size distribution. Thus, the particulate precursor material can have a volume-based particle size distribution with a D₅₀ particle size of less than 200 nm, or less than 150 nm, or preferably less than 100 nm, and/or a span (D₉₀−D₁₀)/D₅₀ of less than 1.5, preferably less than 1.0, or less than 0.8. The D₅₀ particle size indicates the median particle size, below or above which 50% of the population lies, i.e., 50% of the volume of all particles. The D₉₀ particle size accordingly refers to the particle size below which 90% of the population lies, i.e., 90% of the volume of all particles. The D₁₀ particle size refers to the particle size below which 10% of the population lies, i.e., 10% of the volume of all particles. The span calculated as (D₉₀−D₁₀)/D₅₀ is a measure for the breadth of a particle size distribution. The particle size distribution of the particulate precursor material according to the present invention is typically monomodal. The particle size distribution can be measured by laser-diffraction using a LA-950 Laser Particle Size Analyzer from Horiba according to the procedure described in the example section.

The particulate precursor material formed by the flame pyrolysis step can optionally be subjected to a treatment prior to subjecting the particulate precursor material to field-assisted sintering in the process according to the present invention. For example, the particulate precursor material could in principle be subjected to a drying or milling process or a calcination treatment. Calcination may be performed at temperatures between 630° C. and 770° C. Calcination time may be in the range of 4.5 hours to 5.5 hours. Atmosphere during calcination is not that important: It may be either inert or in presence of Oxygen. Calcination may be performed in a dedicated calcination equipment such as a muffle furnace. Alternatively, calcination treatment may be performed by means of sintering equipment before starting actual sintering process. In all cases, aim of calcination treatment is transfer of amorphous powder structure to crystalline powder structure. If crystallization during calcination leads to unappropriated increase of particle size, a deagglomeration step may be performed between calcination step and sintering step.

Contrary to the particles obtained through sol-gel or melt-quenching processes, it is an advantage of present invention that the particulate precursor material obtained from flame pyrolysis can directly be used for sintering, and does not require any treatment prior to the sintering process. In particular, due to the high flame temperatures, organic and other constituents, which would reduce the sintering ability of the particulate precursor material are substantially removed. Accordingly, the particulate precursor material according to the invention is preferably subjected to field-assisted sintering without any further treatment steps such as drying, milling or a calcination. If a calcination step is needed for crystallizing amorphous powder obtained by flame pyrolysis, said calcination step may be performed with the same equipment used for subsequent sintering step.

The method according to the present invention further comprises subjecting the particulate precursor material to field-assisted sintering to form the lithium titanium phosphate based solid electrolyte material. Generally, field-assisted sintering as understood herein refers to a sintering process also known as spark plasma sintering (SPS) which applies heat generated by an electrical field and pressure to sinter a particulate material to form a solid, compacted workpiece. Field-assisted sintering according to the present invention can be carried out using conventional field-assisted sintering systems as are commercially available for example from Dr. Fritsch GmbH & Co. KG (Fellbach, Germany), FCT Systeme GmbH (Effelder-Rauenstein, Germany) and Sumitomo Coal Mining Co. Ltd. (Tokyo, Japan). Such field-assisted sintering systems comprise a mold, which is loaded with the particulate precursor material and which can be placed under a controlled atmosphere, as well as a mechanical loading system, which acts at the same time as high-power electrical circuit. Thus, during field-assisted sintering the particulate precursor material can be subjected simultaneously to high sintering temperatures as well as pressures on the order of several tens of MPa. Field-assisted sintering typically has several advantages compared to conventional sintering processes like tape-casting. Thus, field-assisted sintering can provide sintered microstructures with comparatively small grain sizes which positively influences both the ion-conductivity and mechanical properties of the resulting solid electrolyte material. One important factor determining the grain size can be seen in the comparatively high heating rates and short holding and process times attainable by field-assisted sintering compared to conventional furnace sintering processes. Short holding and process times may significantly reduce energy costs compared to conventional furnace heating. Contrary to conventional external heating, e.g., by means of an oven, the sample may be heated in case of field-assisted sintering directly based on the ohmic resistance of the particulate material in the mold. Compared to cold pressing prior to the sintering process, the application of pressure during heating to the sintering temperature can provide solid electrolytes with a reduced amount of or substantially no pores and with increased density. This may result in solid electrolyte materials with both high ion-conductivity and high mechanical reliability.

Field-assisted sintering according to the present invention may accordingly comprise providing the particulate precursor material in a mold between a pair of electrodes, applying pressure to the particulate precursor material and passing an electrical current by the electrodes through the mold and/or the particulate precursor material. The particulate precursor material can optionally be mixed with one or more than one further substance prior to the field-assisted sintering. Preferably, however, no further substances are intentionally added to the particulate precursor material subjected to field-assisted sintering. Field-assisted sintering may accordingly comprise subjecting the particulate precursor material to a defined temperature and pressure program. Precise temperature control of the material within the mold may be achieved by applying a defined voltage difference to two, each other opposing electrodes, which are in electrical contact with the material within the mold in combination with a temperature measurement and regulation system. The electrical current resulting from the applied voltage difference can be an alternating or direct current. Optionally, the electrical current can be pulsed. For example, such pulses can have a frequency of between 1 Hz and 20 KHz and a length of between 50 μs and 999 ms. Depending on the electrical conductivity of the material, an electrically insulating mold can be utilized thus forcing the current through the material within the mold leading to an efficient internal heating of the material. Additional heat sources like an induction heat source can optionally be utilized to heat the material within the mold. Field-assisted sintering according to the present invention can comprise heating the particulate precursor material within the mold to a sintering temperature of 700° C. or more, such as 750° C. or more, or 800° C. or more, or 850° C. or more, or 900° C. or more or 950° C. or more. For example, the particulate precursor material can be heated to a sintering temperature of 1500° C. or less, such as 1300° C. or less, such as 1100° C. or less, or 1000° C. or less, or 950° C. or less, or 900° C. or less. Field-assisted sintering can comprise heating the particulate precursor material to a sintering temperature in a range between any of the above recited values such as to a sintering temperature in a range from 700° C. to 1100° C., such as from 800° C. to 1000° C. Preferably the sintering temperature is between 850° C. and 950° C. Temperatures higher than 1000° C. may be less preferred as they may lead to enhanced grain growth. The temperature can be increased to the sintering temperature linearly, i.e., with a constant heating rate, or non-linearly, e.g. in a stepwise manner (with a holding period at one or intermediate temperatures) or in a steady manner, but with time-variable heating rates. Heating rates of up to 1000 K/min can be applied. Typically, however, a heating rate such of 10 K/min or more, such as 25 K/min or more, or 50 K/min or more, or 60 K/min or more is used. The heating rate can for example be 200 K/min or less, such as 100 K/min or less, or 80 K/min or less. Heating rates in a range between any of the above-mentioned values can be applied, such as in a range from 10 to 200 K/min or from 20 K/min to 100 K/min. The heating rate can be calculated from the difference between the sintering temperature and the starting temperature and the heating time required to reach the sintering temperature. Sintering temperature means herein the maximum temperature to which the particulate precursor material is heated in the field-assisted sintering step.

Field-assisted sintering according to the present invention further comprises applying pressure to the particulate precursor material. Optionally, the material within the mold can be pre-densified before being loaded in the field-assisted sintering device or before increasing the temperature to the sintering temperature. Pressure during field-assisted sintering can be generated by applying a force on the material within the mold by means of the mechanical loading system (e.g. a press) of the field-assisted sintering device. For instance, one of the opposing electrodes can be moveable and have a form which tightly closes a surface of the mold. Applying force in the direction of and along the mold by the electrodes results in a pressure on the material within mold, which is determined by the surface area of the contact area of the electrode being in contact with the material and the force exerted by the movable electrode in the direction of the sample. For example, the mold can have a form of a hollow cylinder, whereby one end of the cylinder is closed, i.e., the base of the mold, and the opposing end is open. In this case, the moveable electrode has a circular contact area with a diameter corresponding to the inner diameter of the cylinder. This electrode is co-aligned with the open side of the cylindrical mold and can therefore compress the material filled within mold by pressing against the other, opposing electrode.

The pressure applied to the sample during field-assisted sintering typically varies over time. For example, pressure can be increased at a constant rate or at different rates from zero to a maximum pressure. Pressure can be applied before the temperature of the sample is raised over room temperature or pressure can be applied after heating has been started or after the maximum temperature has been reached. For example, before the temperature of the sample is raised above room temperature, a preload pressure such as a pressure in a range from 5-15 MPa can be applied. Then, pressure on the sample can be increased to the sintering pressure with a constant rate or with a variable rate while simultaneously increasing the temperature to the sintering temperature. Field-assisted sintering according to the present invention can comprise subjecting the particulate precursor material to a sintering pressure of 20 MPa or more, such as 30 MPa or more, or 40 MPa or more, or 50 MPa or more, or 60 MPa or more. Field-assisted sintering can comprise applying to the particulate precursor material a sintering pressure of 70 MPa or less such as 60 MPa or less, or 50 MPa or less, or 40 MPa or less. Field-assisted sintering can comprise subjecting the particulate precursor material to a sintering pressure in a range between any of the above recited values such as to a sintering pressure in a range from 20 to 70 MPa, such as from 30 to 50 MPa. The pressure can be increased to the sintering pressure linearly, i.e., with a constant rate, or non-linearly, e.g. in a stepwise manner (with a holding period at one or intermediate pressures) or in a steady manner, but with time-variable pressure increase rates. The pressure can be increased for example at a constant rate of 0.5 MPa/min or more, such as 1 MPa/min or more, or 2 MPa/min or more, or 3 MPa/min or more. The pressure can be increased for example at a rate of 10 MPa/min or less, or MPa/min or less, or 3 MPa/min or less. The pressure can be increased with a rate in a range between any of the above-mentioned values, such as in a range from 0.5 MPa/min to 10 MPa/min or from 1 MPa/min to 5 MPa/min. The rate of the pressure increase can be calculated from the difference between the sintering pressure and the starting pressure and the time required to reach the sintering pressure. Sintering pressure means herein the maximum pressure which is applied to the particulate precursor material in the field-assisted sintering step. Typically, the pressure is increased while heating the sample to the sintering temperature. In other words, the temperature and pressure may preferably be increased simultaneously during a portion of the temperature and pressure program.

The field-assisted sintering in the process according to the present invention can further comprise keeping the particulate precursor material time at the sintering temperature and sintering pressure for a holding time. The holding time at the sintering temperature and sintering pressure can for example be 1 min or more such as 2 min or more, or 3 min or more, or 4 min or more, or 5 min or more. It can for example be 10 min or less, such as 8 min or less, or 6 min or less. The holding time can be between any of the indicated values such as from 1 min to 10 min such as from 2 min to 8 min, or from 3 min to 6 min. Although not preferred, it is also possible to apply a temperature and pressure program in which there is no temporal overlap of the sintering temperature and the sintering pressure being applied.

Field-assisted sintering according to the present invention can further comprise reducing the temperature from the sintering temperature at a constant or a variable rate. The temperature of the material within the mold can be decreased by reducing or switching off the current applied to the electrodes and the optional further heat source. Additionally, the electrodes of the sintering device may be actively cooled, e.g. by means of a cooling liquid such as water, which can increase the cooling rate of the mold. The pressure may be reduced before, concomitantly and/or after the temperature is reduced from the sintering temperature. The pressure can be reduced from the sintering pressure at a constant or a variable rate. This can be achieved by reducing or removing the applied mechanical force.

Field-assisted sintering of the particulate precursor material can be carried out under vacuum and/or a protective gas atmosphere. The protective gas atmosphere can for example comprise nitrogen, argon or any other gas or gas mixture, which is essentially inert at the temperatures reached during the field-assisted sintering process.

According to the process described above, a solid electrolyte material is thus obtainable. The formed solid electrolyte material is a lithium titanium phosphate based material. The precise composition depends on the type and relative amounts of the different source materials used. The formed particulate precursor material can in particular have a composition according to the formula Li_{n-(1+x+y+z)}M_{n′-x}Ti_{n″-(2-x)}(PO₄)_{(n″′)-(3-y)}(SiO₄)_{(n″″)-y}, wherein M is a metal selected from the group of Al, Ga, Ge, In, Sc, V, Cr, Mn, Co, Fe, Y, the lanthanides or a combination thereof, 0≤x≤1, 0≤y≤1, and 0≤z≤0.8. The parameters n, n′, n″, n″′ and n″″ can each individually be a number in a range from 0.8 to 1.2, such as from 0.9 to 1.1 or from 0.95 to 1.05, such as about or equal to 1. Li can optionally be provided in excess compared to the stoichiometry according to the above formula Li_{(1+x+y)}MₓTi₍₂₋ₓ₎(PO₄)_{3-y}(SiO₄). This is reflected by the parameter z in the above compositional formula. The parameter z can be 0≤z≤0.8, such as 0≤z≤0.6, or 0≤z≤0.5, 0≤z≤0.3 or 0≤z≤0.2 or 0≤z≤0.1. When no lithium excess is used, z is 0.

The solid lithium titanium phosphate based electrolyte material can comprise one or more than one solid phase. Thus, the solid electrolyte material of the present invention can, for example, comprise multiple phases, which differ in crystallinity and/or elemental composition. The lithium titanium phosphate based solid electrolyte material can in particular comprise one or more phases, which have a composition represented by the formula Li_{(1+X+y)}MₓTi₍₂₋ₓ₎(PO₄)_{3-y} (SiO₄)_{y}, wherein M is a metal selected from the group of Al, Ga, Ge, In, Sc, V, Cr, Mn, Co, Fe, Y, the lanthanides or a combination thereof, 0≤x≤1 and 0≤y≤1. Illustrative non-limiting examples of such phases include Li₍₁₊ₓ₎AlₓTi₍₂₋ₓ₎(PO₄)₃, with 0≤x≤1, such as Li_{1.3}Al_{0.3}Ti_{1.7}(PO₄)₃, or Li_{1.5}Al_{0.3}Ti_{1.7}(PO₄)_{2.8}(SiO₄)_{0.2}, Li_{1.8}Al_{0.4}Ti_{1.6} (PO₄)_{2.6} (SiO₄)_{0.4}, Li_{2.0}Al_{0.4}Ti_{1.6}(PO₄)_{2.4} (SiO₄)_{0.6} or Li_{1.75}Al_{0.6}Ti_{1.4}(PO₄)_{2.85}(SiO₄)_{0.15}. Such phases can crystallize in the NASICON-type crystal structure and provide Li ion conductivity to the solid electrolyte material. Optionally further phases can be present in addition to the one or more phases, which have a composition represented by the formula Li_{(1+X+y)}MₓTi₍₂₋ₓ₎(PO₄)_{3-y}(SiO₄)_{y}. For instance, the formed solid electrolyte material according to the present invention may comprise one or more phases, which have a composition represented by the formula Li_{(1+x+y)}MₓTi₍₂₋ₓ₎(PO₄)_{3-y} (SiO₄)_{y} in a total amount of at least 70 wt. %, preferably at least 80 wt. % or at least 90 wt. %, based on the total weight of the solid electrolyte material. The type and amount of phases present in the solid electrolyte material can be determined by x-ray diffraction (XRD) analysis.

The parameter x in the above-mentioned formulas for a possible composition of the solid electrolyte and certain phases therein is generally 0≤x≤1. In particular, in the composition of the solid electrolyte material x can be greater than or equal to 0.05, or greater than or equal to 0.10, or greater than or equal to 0.15, or greater than or equal to 0.20, or greater than or equal to 0.25, or greater than or equal to 0.30, or greater than or equal to 0.35, or greater than or equal to 0.40, or greater than or equal to 0.45, or greater than or equal to 0.50, or greater than or equal to 0.55, or greater than or equal to 0.60. The parameter x can be less than or equal to 0.95, or less than or equal to 0.90, or less than or equal to 0.85, or less than or 0 equal to 0.80, or less than or equal to 0.75, or less than or equal to 0.70, or less than or equal to 0.65, or less than or equal to 0.60, or less than or equal to 0.55, or less than or equal to 0.50, or less than or equal to 0.45, or less than or equal to 0.40. The parameter x can be in a range between any of the recited values such as for example in a range from 0.05 to 0.95, or from 0.10 to 0.90, or from 0.20 to 0.70, or from 0.30 to 0.60, or from 0.40 to 0.60.

The parameter y in the above-mentioned formulas for a possible composition of the solid electrolyte and certain phases therein is generally 0≤y≤1. In particular, in the composition of the solid electrolyte material y can be greater than or equal to 0.05, or greater than or equal to 0.10, or greater than or equal to 0.15, or greater than or equal to 0.20, or greater than or equal to 0.25, or greater than or equal to 0.30, or greater than or equal to 0.35, or greater than or equal to 0.40, or greater than or equal to 0.45, or greater than or equal to 0.50. The parameter y can for example be less than or equal to 0.80, or less than or equal to 0.70, or less than or equal to 0.60, or less than or equal to 0.50, or less than or equal to 0.40, or less than or equal to 0.30, or less than or equal to 0.20, or less than or equal to 0.10, or less than or equal to 0.05. The parameter y can be in a range between any of the recited values such as in a range from 0 to 1, or from 0 to 0.80, or from 0.05 to 0.60, or from 0.10 to 0.60. In specific variants, the parameter y can be 0.

When the solid electrolyte material includes a metal M, the metal M can be selected from the group of Al, Ga, Ge, In, Sc, V, Cr, Mn, Co, Fe, Y, the lanthanides or a combination thereof. The metal M, when used, can in particular comprise or be aluminum. In one embodiment of present invention, M is a combination of Al and Ge. The solid electrolyte material of that embodiment is named LAGTP. An example for LAGTP is Li_{1.45}Al_{0.45}Ge_{0.2}Ti_{1.35}P₃O₁

The solid electrolyte material of the present invention can be characterized by its elastic modulus E, also known as Young's modulus. The elastic modulus E describes the stress strain relationship of the material in the elastic regime and can be determined for example by nanoindentation as described in the experimental section. It has surprisingly been found that the solid electrolyte materials according to the present invention can have an exceptionally high elastic modulus E. The elastic modulus E of the solid electrolyte material can for example be 200 GPa or more, such as 300 GPa or more, such as 350 GPa or more, or 400 GPa or more, or 500 GPa or more, or 600 GPa or more, or 700 GPa or more, or 750 GPa or more, or 800 GPa or more. The solid electrolyte material can for example have an elastic modulus of up to 1,000 GPa, or up to 900 GPa. Preferably, the solid electrolyte material according to the present invention has an elastic modulus E of 700 GPa or more, such as from 700 to 1,000 GPa.

The solid electrolyte material of the present invention can furthermore be characterized by its specific ionic conductivity. The specific ionic conductivity can be determined by impedance spectroscopy according to the method described in the experimental section. The solid electrolyte material of the present invention can for example have a specific ionic conductivity of 1.10-5 S/cm or greater, such as 2.10-5 S/cm or greater, or 5.10-5 S/cm or greater. The solid electrolyte material of the present invention can for example have a specific ionic conductivity of 0.5·10⁻⁵ S/cm or greater such as in a range from 0.5·10⁻⁵ S/cm to 1·10⁻³ S/cm. The specific ionic conductivity refers to the specific ionic conductivity at room temperature (20° C.), if not indicated otherwise herein.

Typically, the solid lithium titanium phosphate based electrolyte material obtained by the process disclosed herein is in the form of a coherent body. Thus, field-assisted sintering according to the present invention provides a solid lithium titanium phosphate based electrolyte material in the form of a coherent macroscopic body with defined outer dimensions, which can optionally be adapted e.g. by cutting or grinding. The solid electrolyte may also be crushed under formation of a powder depending on the respective intended use.

The solid electrolyte material of the present invention can have a high density. Thus, the solid electrolyte material of the present invention can have a density of 95% or greater, such as 97% or greater, based on the theoretical density of the material. The density can be determined by the Archimedes principle.

The solid lithium titanium phosphate based electrolyte material obtained according to the present invention can generally be used in any application, where solid ion-conducting material and in particular lithium ion-conducting material is conventionally employed or useful. The solid lithium titanium phosphate based electrolyte material of the present disclosure can for example be employed as or comprised in a Li-ion conductor, a solid electrolyte, an electrode, or a separator e.g. for all-solid or hybrid Li-ion batteries. The solid lithium titanium phosphate based electrolyte material can also find applications in salt water batteries and osmosis processes.

Accordingly, the present invention also concerns articles comprising the solid electrolyte material disclosed herein. The article can for example be a solid electrolyte, electrode, separator or a membrane.

Due to its exceptionally high elastic modulus, the solid electrolyte material according to the present invention is especially suited for industrial applications such as industrial electrolysis processes. Thus, the present invention is also directed towards a membrane, such as a ceramic membrane, comprising or consisting of the solid lithium titanium phosphate based electrolyte material disclosed herein for use in a process for separation and recycling of lithium from end-of-use lithium-containing devices such as lithium-containing batteries.

The present disclosure also relates to energy storage devices, such as in particular a lithium battery, comprising a solid electrolyte, electrode and/or separator comprising the solid electrolyte material provided by the present invention.

Having generally described the present invention above, a further understanding can be obtained by reference to the following specific examples. These examples are provided herein for purposes of illustration only, and are not intended to limit the present invention, which is rather to be given the full scope of the appended claims including any equivalents thereof.

### EXAMPLES

### Example 1

### Preparation of a Solution of Source Materials

8.26 kg of a solution containing 1949 g of a commercial solution (Borchers® Deca Lithium 2 from Borchers GmbH, Langenfeld, DE), with 2 wt. % Li in the form of lithium neodecanoate, 558 g of a commercial solution (TIB KAT 851 from TIB Chemicals AG, Mannheim, DE), with 4.5 wt. % Al in the form of aluminium-ethylacetoacetate, 1529 g of a commercial solution (TIB KAT 530 from TIB Chemicals AG, Mannheim, DE), with 16.5 wt. % Ti in the form of tetrapropylorthotitanate, 1729 g of a commercial solution (4001 from Alfa Aesar, Heysham, GB), with 16.66 wt. % P in the form of triethyl phosphate, and 2500 g of a solution containing 50 wt. % ethylhexanoic acid and 50 wt. % of ethanol were combined and mixed at room temperature. The result was a clear solution without visible precipitates.

### Flame Pyrolysis

Subsequently, a particulate precursor material was prepared from the obtained solution by flame pyrolysis. To this end, an aerosol was formed by spraying the solution at a throughput of 2.5 kg/h together with 15 Nm³/h air via a two-component nozzle into a flame within a tubular reaction chamber under formation of a particulate precursor material. The flame was generated by burning hydrogen supplied at a rate of 8.0 Nm³/h with air supplied at a rate of 75 Nm³/h. Additionally, 25 Nm³/h of secondary air was introduced into the tubular reaction chamber. The reaction gases comprising the particulate precursor material leaving the tubular reaction chamber were cooled down and the particulate precursor material was then separated from the reaction gases by filtering. The thus obtained particulate precursor material had a composition corresponding to Li_{1.82}Al_{0.3} Ti_{1.7}P₃O₁₂, as determined by the relative amounts of the Li source material, Ti source material, P source material and source material of aluminium in the solution subjected to flame pyrolysis.

The particle size distribution of the obtained particulate precursor material was determined by laser diffraction analysis using a Horiba LA-950-V2 laser particle size analyzer from HORIBA Europe GmbH, Oberursel, Germany with software version 8.3 (P001793B)). To this end, a dispersing medium of water to which has been added five droplets Dolapix CE64 (Zschimmer & Schwarz Chemie GmbH, Lahnstein, Germany) was provided in the fluid system of the device. The dispersing medium was stirred (speed setting 6) and circulated through an in-line ultrasonic probe (30 W) and a flow cell by means of a pump. About a tip of a spatula of the particulate precursor material to be analyzed was then added to the agitated dispersing medium. The particle size measurement was started five minutes after the addition of the sample under constant application of ultrasound. The volume-based particle size distribution was determined by the instrument software using Mie theory based on the measurement data and using refractive indices for the solvent of 1.333 and for the particles of 1.590-0.000i, respectively. The measured particle size distribution is shown in FIGS. 2 and D₁₀, D₅₀, and D₉₀ values derived therefrom are reported in Table 1 below.

### Calcination Treatment

The particulate precursor material obtained from the above flame pyrolysis process was then subjected to an additional calcination treatment at 700° C. under inert atmosphere. A calcinated precursor material has been obtained.

### Field-Assisted Sintering

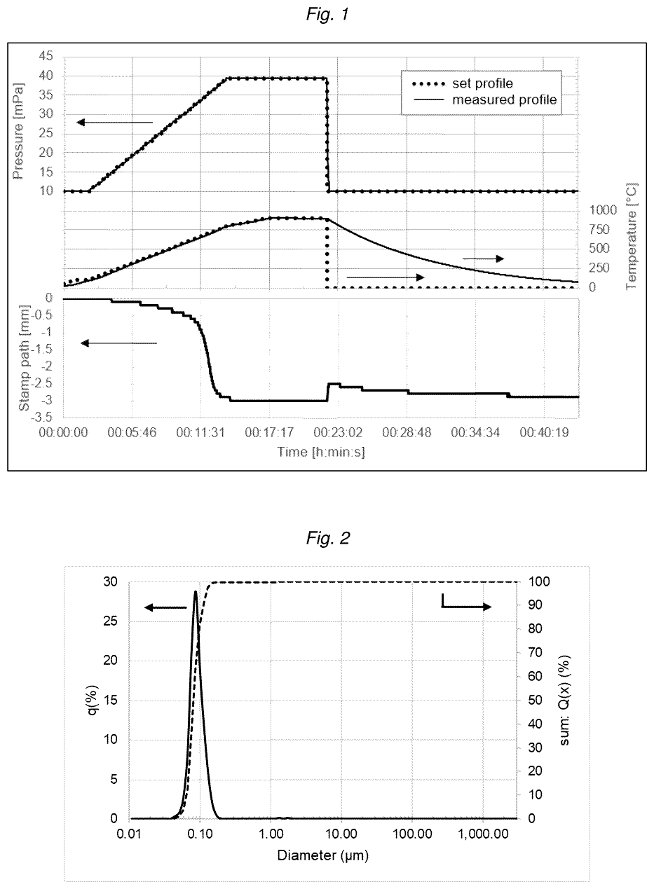

The calcinated precursor material obtained from the above calcination treatment was then subjected to field-assisted sintering to form therefrom a lithium titanium phosphate based solid electrolyte material. Field-assisted sintering was carried using a DSP515-725 of Dr. Fritsch GmbH & Co. KG (Fellbach, Germany). To this end, 5 g of the precursor material were filled into a cylindrical graphite mold with a circular opening at one end. The opening of the mold was tightly closed by a circular stamp. The thus prepared mold was transferred into the oven chamber of the field-assisted sintering device. The oven chamber was set under a nitrogen atmosphere. Increasing pressure was then exerted to the sample contained within the mold by the stamp and an alternating electrical current applied to the sample contained within the mold via the pair of electrodes of the field-assisted sintering device. Heating of the sample was solely obtained by means of the electrical current supplied by the electrodes. The time-resolved pressure and heating program applied to the sample together with the path of the stamp is shown in FIG. 1. Accordingly, at the beginning of the program the sample was heated from room temperature to the sintering temperature of about 900° C. with a heating rate of about 50 K/min. The initial pressure was set to 10 MPa and was then increased at rate of about 3 MPa/min up to a maximum pressure of about 40 MPa. The maximum temperature of about 900° C. was reached after about 17 minutes and the maximum pressure was reached after about 13 minutes. When both the maximum temperature and the maximum pressure were reached, temperature and pressure were kept constant for a holding time of about 5 min. Subsequently, the sample was depressurized and cooled down to room temperature within 20 min by switching off the voltage applied to the electrodes and under water-cooling of the electrodes. After cooling, the formed solid electrolyte material in the form of a coherent body was separated from the graphite mold.

### Example 2

A particulate precursor material was prepared as described above for Example 1, except that the particulate precursor material was not submitted to an additional calcination treatment. Thus, the particulate precursor obtained by flame pyrolysis was subjected to field assisted sintering according to the procedure described above with respect to Example 1 to form therefrom a lithium titanium phosphate based solid electrolyte material.

### Comparative Example 1

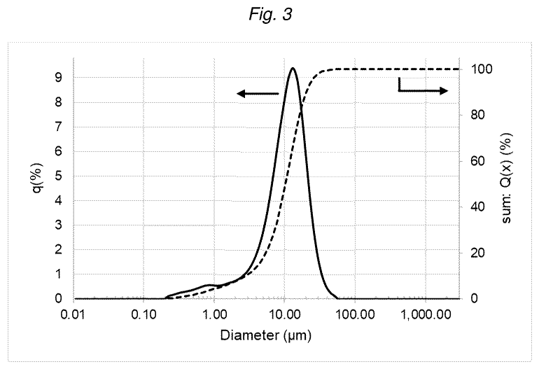

A commercially available LATP particulate precursor material was obtained from Toshima Manufacturing Co., Ltd., Saitama, Japan (Lot. 00081034). The material had a composition corresponding to Li_{1.3}Al_{0.3}Ti_{1.7}P₃O₁₂. The particle size distribution of this particulate precursor material was determined by laser diffraction analysis according to the procedure described above for Example 1 except for using a refractive index for the particles of 1.980-0.100i. The measured particle size distribution is shown in FIGS. 3 and D₁₀, D₅₀, and Doo values derived therefrom are reported in Table 1 below. A solid electrolyte material was prepared from this precursor material by field-assisted sintering carried according to the procedure described above with respect to Example 1.

The solid electrolyte materials obtained according to Example 1, Example 2 and Comparative Example 1 were analyzed for their mechanical properties and electrical properties as follows:

### Analysis of Mechanical Properties by Nanoindentation

The mechanical properties of the of solid electrolyte materials were analyzed using nanoindentation measurements. For the nanoindentation measurements, samples of the solid electrolyte materials were used as obtained from the field assisted sintering without polishing. Nanoindentation measurements were performed with a standard Picodentor HM500 (Helmut Fischer GmbH, Sindelfingen, Germany) equipped with a Vickers diamond tip (pyramidal indenter with opposing faces at a semi-angle of θ=68° and therefore making an angle β=22° with the flat specimen surface). All samples were indented in force-controlled mode with maximum loads of 10 mN, 50 mN, 100 mN and 500 mN. Individual indents were carried out by applying a trapezoidal load function as defined by a loading time of 20 s, a holding time at a maximum load of 5 s, and an unloading time of 20 s. For each load 2×2 indents on an area of 100×100 μm² were recorded. Thermal drift was measured and corrected for each indentation.

The force displacement curves were analyzed using software based on the Oliver-Pharr method described in Journal of Materials Research, Volume 7, Issue 6, June 1992, pp. 1564-1583, doi: https://doi.org/10.1557/JMR.1992.1564. First, the curve was shifted to the first contact point. Zero displacement was defined as the onset of repulsive force during approach/loading. The reduced elastic modulus Eᵣ was determined according to the formula

$${E}_{r} = \frac{\sqrt{π}}{2} \frac{S}{\sqrt{A}} ,$$

with S being the initial unloading stiffness and A the projected contact area at the peak load. To this end, S was determined by applying a linear fit to the experimentally measured unloading curve of the recorded force displacement curve and by utilizing

$$S = \frac{dP}{dh} ,$$

wherein dP is the applied force difference and dh the displacement difference. The upper and lower fit range was set to 95-60% of the unloading curve. A was calculated utilizing A=4h_{c}² tan²θ (ideal Vickers indenter), whereby h_{c} is given by h_{c}=

$${h}_{max} - 0.75 \frac{{P}_{max}}{S} ,$$

with hₘₐₓ and Pₘₐₓ being the maximum displacement and maximum applied load, respectively. The elastic modulus E of the sample was calculated according to

$$E = ( 1 - {v}^{2} ) \times [ \frac{1}{E \text{?}} - \frac{( 1 - v \text{?} )}{{E}_{i}} ] \text{?}$$

$$\text{?} \text{indicates text missing or illegible when filed}$$

wherein Eᵢ and vᵢ are the elastic modulus and Poisson's ratio of the indenter, respectively. For the utilized indenter, the elastic modulus Eᵢ was 1140 GPa and the Poisson's ratio vᵢ was 0.07. v is the Poisson's ratio of the sample, which was defined as 0.3 for the samples analyzed herein. The hardness was calculated as

$$H = \frac{{P}_{max}}{A}$$

and the yield strength σy was calculated as

$${σ}_{y} = \frac{H}{2.8} .$$

Elastic moduli, yield strengths and hardness' thus determined for the plurality of performed indentations for each sample were then averaged (arithmetic mean). Table 1 reports the determined averaged elastic moduli, yield strengths and hardness values and standard deviations for the investigated solid electrolyte materials.

### Impedance Spectroscopy

Electrochemical impedance spectroscopy of the obtained solid electrolyte materials was carried out as follows:

The measurement setup comprised two cylindrical electrodes between which the sample was placed. A weight was placed on top of the sample to ensure an optimal contact with the electrodes and a reproducible contract pressure. A potentiostat (ZAHNER-elektrik I. Zahner-Schiller GmbH & Co. KG, Kronach-Gundelsdorf, Germany) was connected to the electrodes and controlled by the Thales software (ZAHNER). Measurements were carried out on samples, which were polished and sputtered with a thin, conductive layer of Au, in a frequency range from 1 Hz to 4 MHz using an amplitude of 5 mV.

Measurement results were plotted in the form of Nyquist diagrams and analyzed using the software Analysis (ZAHNER). The electrical resistance was read at the curve maximum in the Nyquist diagram. The specific conductivity σ [mS/cm] was then calculated based on the formula

$$σ = \frac{h \cdot {10}^{4}}{R \cdot \frac{π}{4} \cdot {d}^{2}}$$

with h being the height of the plate in mm, R the measured electrical resistance in Ω and d the diameter in mm. The determined specific conductivity σ is reported in Table 1 for the investigated solid electrolyte materials.

TABLE 1

| | | |
|---|---|---|
| | | Comparative |
| Example 1 | Example 2 | Example 1 |

Particle size distribution of precursor material

| | | | |
|---|---|---|---|
| D₁₀ | μm | 0.064 | 2.792 |
| D₅₀ | μm | 0.082 | 10.333 |
| D₉₀ | μm | 0.112 | 20.252 |
| Span (D₉₀ − D₁₀)/ | | 0.58 | 1.69 |
| D₅₀ | | | |

Properties of solid electrolyte material

| | | | | | |
|---|---|---|---|---|---|
| E modulus | mean | GPa | 860 | 814 | 188 |
| | stand. | | 249 | 242 | 56 |
| | dev. | | | | |
| hardness | mean | GPa | 139 | 122 | 33 |
| | stand. | | 43 | 34 | 19 |
| | dev. | | | | |
| yield strength | mean | GPa | 50 | 44 | 12 |
| | stand. | | 15 | 12 | 7 |
| | dev. | | | | |

| | | | | |
|---|---|---|---|---|
| specific conductivity | S/cm | 0.7 · 10⁻⁴ | 0.7 · 10⁻⁴ | 0.7 · 10⁻⁴ |

As evident from the results shown in Table 1, the combination of flame pyrolysis and field-assisted sintering in the process according to the present invention provides solid electrolyte materials with enhanced mechanical properties compared to a reference material based on a conventional commercially available particulate precursor material. In particular, the solid electrolyte materials of Examples 1 and 2 are characterized by an exceptionally high elastic modulus compared to the Comparative Example. Without intending to be bound to any theory, it is believed that one reason for this may reside in the significantly smaller particle sizes and the narrower particle size distribution of the particulate precursor material obtained by flame pyrolysis as disclosed herein compared to the conventional particulate material of Comparative Example 1 (cf. Table 1 and FIGS. 2 and 3). Smaller particles are believed to provide a reduced grain size in the solid electrolyte material which may lead to a decreased probability of microcrack formation and thus enhanced reliability against mechanical breakdown. The comparison of the elastic modulus E, hardness and yield strength of Examples 1 and 2 furthermore demonstrates that a calcination treatment of the particulate precursor material prior to field-assisted sintering does not further improve the mechanical properties of the resulting solid electrolyte materials. Therefore, the particulate precursor material obtained from flame pyrolysis can be subjected to field assisted sintering without any intermediate treatment steps and still provide a solid electrolyte material with beneficial mechanical properties and especially an exceptionally high elastic modulus. Moreover, the specific conductivity of the solid electrolyte material produced by the process according to the present invention is of a magnitude comparable to conventional solid electrolyte materials with similar composition, which typically exhibit a specific conductivity on the order of 10⁻⁵-10⁻³ S/cm. Accordingly, the process of the present invention provides solid electrolyte materials which exhibit enhanced mechanical properties, including an exceptionally high elastic modulus, while at the same time having competitive conductivity.

Additionally, the solid electrolyte materials obtained according to Example 1 and Comparative Example 1 were analyzed for their crystalline structure with X-ray diffraction at a wavelength amounting to 1.5406 nm. Results of the semiquantitative analysis are given in Table 2.

TABLE 2

| | Compound | | | | |
|---|---|---|---|---|---|
| Sample | LiTi₂P₃O₁₂ | LiTiOPO₄ | Li_{0.45}TiO₂ | AlPO₄ | SiO₂ |
| Comparative | 98.7% | 0 | 0 | 1.3% | 0 |
| Example 1 | | | | | |
| Example 1 | 51.2% | 46.2% | 0.5% | 0 | 2 |

In Table 2, compound LiTi₂P₃O₁₂ represents ion-conducting LATP (Lithium-Aluminum-Titanium-Phosphate), as the crystalline structure of LATP and LiTi₂P₃O₁₂ are identical.

### Example 3

6.62 kg of a solution containing 1336 g of a commercial solution (Borchers® Deca Lithium2), with 2 wt % Lithium in the form of Lithium neodecanoate, 699 g of a commercial solution (TIB KAT 851), with 4.5 wt % Al in the form of aluminium-ethylacetoacetate, 1014 g of a commercial solution (TIB KAT 530), with 16.5 wt % Ti in the form of tetrapropylorthotitanate, 131 g of a solution with 28.7 wt % Ge in the form of germanium tetraethoxide and 1444 g of a commercial solution (Alfa Aesar), with 16.66 wt % Phosphorous in the form of triethyl phosphate and 2000 g of a solution containing 50 wt % ethylhexanoic acid and 50 wt % of ethanol were mixed, resulting in a clear solution. This solution corresponding to a composition of Li_{1.45}Al_{0.45}Ge_{0.2}Ti_{1.35}P₃O₁ (LAGTP)

An aerosol of 2.5 kg/h of this solution and 15 Nm3/h of air was formed via a two-component nozzle and sprayed into a tubular reaction with a burning flame. The burning gases of the flame consist of 8.0 Nm3/h hydrogen and 75 Nm3/h of air. Additionally, 25 Nm3/h secondary air was used. After the reactor the reaction gases were cooled down and filtered.

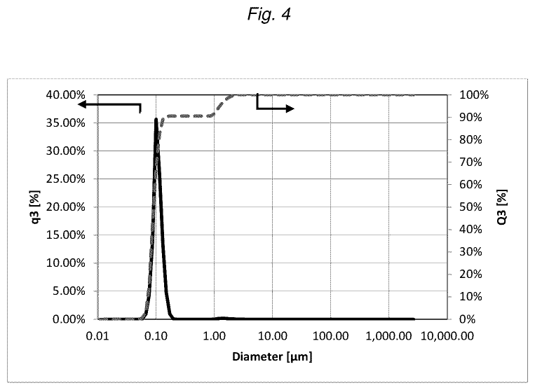

The LAGTP precursor material obtained in Example 3 has been subjected to a particle size distribution analysis by laser scattering using the same LA-950 Laser Particle Size Analyzer from Horiba as before. Results are shown in FIG. 4. The average particle size of the LAGTP precursor is d₅₀=90 nm. The particle size distribution is monomodal.

### Example 4

The precursor powder obtained in Example 3 is amorphous. For better sintering results the amorphous powder is crystallized in an additional temperature treatment at 700° C. for 5 hours. The temperature treatment is followed by a deagglomeration step. The then obtained nano powder is spark plasma sintered. During sintering, powder was subjected to elevated temperature and pressure. A pressure of 45 MPa was applied. Temperature regime comprises several segments. In a first segment, the temperature is increased with a heating rate of 60 K/min to 300° C. In the second segment, temperature is increased to the sintering temperature of 650 to 950° C. with a varying heat rate between 40 and 50 K/min. After a dwell time of 1 to 30 minutes the pressure is released, and the cooling phase starts.

LAGTP type sintered material obtained in Example 4 has been subjected to measurements of particle size distribution, mechanical properties and specific conductivity using the same methods and equipment as for Example 1, 2 and Comp. Example 1. Results are given in Table 3.

TABLE 3
Particle size distribution of precursor material

| | | |
|---|---|---|
| D₁₀ | μm | 0.072 |
| D₅₀ | μm | 0.091 |
| D₉₀ | μm | 0.144 |

| | |
|---|---|
| Span (D₉₀ − D₁₀)/D₅₀ | 0.791 |

Properties of solid electrolyte material

| | | | |
|---|---|---|---|
| E modulus | mean | GPa | 869 |
| | stand. | | 73 |
| | dev. | | |
| hardness | mean | GPa | 221 |
| | stand. | | 90 |
| | dev. | | |
| yield strength | mean | GPa | 79 |
| | stand. | | 12 |
| | dev. | | |

| | | |
|---|---|---|
| specific conductivity | S/cm | 2.1 · 10⁻⁴ |

1. A process for producing a lithium titanium phosphate based solid electrolyte material comprising:
i) providing a solution comprising a Li source material, a Ti source material, a P source material and optionally a Si source material and/or a source material of a metal M, wherein M is selected from the group of Al, Ga, Ge, In, Sc, V, Cr, Mn, Co, Fe, Y, the lanthanides or a combination thereof;
ii) generating an aerosol from the solution;
iii) subjecting the generated aerosol to flame pyrolysis to form a particulate precursor material therefrom; and
iv) subjecting the particulate precursor material to field-assisted sintering to form the lithium titanium phosphate based solid electrolyte material.

2. The process according to claim 1, wherein the Li source material, the Ti source material, and the source material of a metal M are each individually selected from an organic salt, an organic complex or an organometallic compound of the respective metal or a combination thereof, and/or wherein the P source material comprises an ester or salt of an oxoacid of phosphorus, preferably an organic phosphate, and/or the Si source material comprises a silicate and/or an organosilicon compound.

3. The process according to claim 1, wherein the solution comprises the Li source material, Ti source material, P source material and optionally the Si source material and/or source material of a metal M in amounts corresponding to an equivalent ratio Li:(Ti, M):(P, Si) of (0.5 to 2):(1.5 to 2.5): 3, preferably of (1.3 to 2):(1.8 to 2.2): 3.

4. The process according to claim 3, wherein the equivalent ratio of M:Ti in the solution is in a range from 0 to 1:2 and/or wherein the equivalent ratio of Si:P in the solution is from 0 to 1:2.

5. The process according to claim 1, wherein the solution comprises at least one organic solvent, wherein the organic solvent preferably comprises an alcohol, ketone, aldehyde, ester, carboxylic acid, hydrocarbon or a combination thereof.

6. The process according to claim 1, wherein generating an aerosol from the solution comprises spraying the solution by means of a nozzle using an atomizing gas, wherein the atomizing gas is preferably selected from oxygen, nitrogen, air or a mixture thereof.

7. The process according to claim 1, wherein subjecting the aerosol to flame pyrolysis comprises contacting the aerosol with a flame, wherein the flame is preferably generated by combusting a combustible gas with an oxidant, wherein more preferably the combustible gas comprises hydrogen and the oxidant comprises air.

8. The process according to claim 1, wherein the formed particulate precursor material has a composition according to the formula Li_{n(1+x+y+z)}M_{n′-x}Ti_{n″-(2-x)}(PO₄)_{(n″′)-(3-y)}(SiO₄)_{(n″″)-y}, wherein M is a metal selected from the group of Al, Ga, Ge, In, Sc, V, Cr, Mn, Co, Fe, Y, the lanthanides or a combination thereof, 0≤x≤1, 0≤y≤1, 0≤z≤0.8, and n, n′, n″, n″′ and n″″ each individually being a number in a range from 0.8 to 1.2.

9. The process according to claim 1, wherein the formed particulate precursor material has a volume-based particle size distribution, as measured by laser diffraction using a LA-950 Laser Particle Size Analyzer from Horiba, with a D₅₀ particle size of less than 200 nm, preferably less than 100 nm, and/or a span (D₉₀−D₁₀)/D₅₀ of less than 1.5, preferably less than 1.0.

10. The process according to claim 1, wherein the field-assisted sintering comprises providing the particulate precursor material in a mold between a pair of electrodes, applying pressure to the particulate precursor material and passing an electrical current by the electrodes through the mold and/or the particulate precursor material.

11. The process according to claim 1, wherein the field-assisted sintering comprises heating the particulate precursor material to a sintering temperature of 700° C. or more, such as 800° C. or more, or 900° C. or more and/or applying a sintering pressure of 20 MPa or more, such as 30 MPa or more, or 40 MPa or more.

12. The process according to claim 11, wherein the particulate precursor material is heated to the sintering temperature with a rate of 10 K/min or more, such as 25 K/min or more, or 50 K/min or more, and/or the pressure is increased to the sintering pressure at a rate of 0.5 MPa/min or more, such as 1 MPa/min or more, or 3 MPa/min or more, wherein the temperature and pressure are preferably increased simultaneously.

13. The process according to claim 11, wherein the field-assisted sintering comprises keeping the particulate precursor material time at the sintering temperature and sintering pressure for a holding time of 10 min or less, such as 8 min or less, or 6 min or less.

14. A solid electrolyte material obtainable according to claim 1.

15. The solid electrolyte material according to claim 14 having a composition according to the formula Li_{n-(1+x+y+z)}M_{n′-x}Ti_{n″-(2-x)}(PO₄)_{(n″′)-(3-y)}(SiO₄)_{(n″″)-y}, wherein M is a metal selected from the group of Al, Ga, Ge, In, Sc, V, Cr, Mn, Co, Fe, Y, the lanthanides or a combination thereof, 0≤x≤1, 0≤y≤1, 0≤z≤0.8, and n, n′, n″, n″′ and n″″ each individually being a number in a range from 0.8 to 1.2.

16. The solid electrolyte material according to claim 14 comprising one or more phases, which have a composition represented by the formula Li_{(1+x+y)}MₓTi₍₂₋ₓ₎(PO₄)_{3-y}(SiO₄)_{y}, wherein M is a metal selected from the group of Al, Ga, Ge, In, Sc, V, Cr, Mn, Co, Fe, Y, the lanthanides or a combination thereof, 0≤x≤1 and 0≤y≤1, wherein the solid electrolyte material preferably comprises these phase(s) in a total amount of at least 70 wt. %, more preferably at least 80 wt. % or at least 90 wt. %, based on the total weight of the solid electrolyte material.

17. The solid electrolyte material according to claim 15, wherein x is in a range from 0.2 to 0.7, such as from 0.3 to 0.6, and/or y is in a range from 0 to 0.8, such as from 0 to 0.6.

18. The solid electrolyte material according to claim 17, wherein y is 0.

19. The solid electrolyte material according to claim 15, wherein M is Al.

20. The solid electrolyte material according to claim 14, wherein the solid electrolyte material has an elastic modulus of 200 GPa or more, such as 300 GPa or more, or 400 GPa or more, or 500 GPa or more, or 600 GPa or more, or 700 GPa or more, or 750 GPa or more, or 800 GPa or more and/or wherein the solid electrolyte material has a specific ionic conductivity of 1·10⁻⁵ S/cm or greater, preferably 5·10⁵ S/cm or greater.

21. An article comprising the solid electrolyte material according to claim 13.

22. The article according to claim 21, wherein the article is a solid electrolyte, electrode, separator or a membrane, such as a membrane for use in a process for separation and recycling of lithium from end-of-use lithium containing batteries.

23. An energy storage device, such as in particular a lithium battery, comprising a solid electrolyte, electrode and/or separator comprising the solid electrolyte material according to claim 13.

24. The process according to claim 1, wherein the particulate precursor material is subjected to a calcination treatment prior subjecting the particulate precursor material to field-assisted sintering.

25. The process of claim 24, wherein calcination is performed at a temperature between 630° C. and 770° C.

26. The process of claim 24, wherein calcination is performed for a time of 4.5 hours to 5 hours.

27. The process according to claim 24, wherein calcination is performed in a dedicated calcination equipment.

28. The process according to claim 27, wherein calcinated particulate precursor material is subjected to a deagglomeration step prior subjecting the particulate precursor material to field-assisted sintering.

29. A subject matter according to claim 1, wherein M is a combination of Al and Gc.
